(19) United States
(12) Patent Application Publication
(10) Pub. No.: US 2012/0062679 A1
(43) Pub. Date: Mar. 15, 2012

(54) INKJET RECORDING APPARATUS AND METHOD

(75) Inventor: Yasuhiro Yokota, Yokohama-shi (JP)

(73) Assignee: KABUSHIKI KAISHA TOSHIBA, Tokyo (JP)

(21) Appl. No.: 13/238,207

(22) Filed: Sep. 21, 2011

Related U.S. Application Data
(63) Continuation of application No. PCT/JP2010/050838, filed on Jan. 22, 2010.

(30) Foreign Application Priority Data
Mar. 30, 2009 (JP) 2009-082990

(51) Int. Cl. B41J 2/01

(52) U.S. Cl. 347/104

(57) ABSTRACT

According to one embodiment, an inkjet recording apparatus includes a conveying unit, an inkjet recording head, and a vibratory unit. The conveying unit is configured to convey a recording medium along a conveying path. The recording medium includes first and second surfaces which are opposed to each other. The inkjet recording head is arranged on the conveying path and is configured to eject an ink toward the first surface to apply the ink to the recording medium. The vibratory unit is configured to apply an ultrasonic vibration to the recording medium. The vibratory unit is arranged on the conveying path downstream of the inkjet recording head and includes an end part configured to make substantially line contact with the second surface along a width direction of the recording medium. The width direction is substantially perpendicular to a conveying direction in which the recording medium is conveyed.

### CROSS-REFERENCE TO RELATED APPLICATIONS

This application is a Continuation Application of PCT Application No. PCT/JP2010/050838, filed Jan. 22, 2010 and based upon and claiming the benefit of priority from prior Japanese Patent Application No. 2009-082990, filed Mar. 30, 2009, the entire contents of all of which are incorporated herein by reference.

### FIELD

Embodiments described herein relate generally to an inkjet recording apparatus which forms an image on a recording medium by ejecting water-based ink from an inkjet recording head.

### BACKGROUND

In general, an inkjet recording apparatus which forms images by using inks is capable of forming high-quality images on recording media (hereinafter referred to as sheets) such as ordinary sheets. Also, inkjet recording apparatuses have advantages such as low running costs, high safety, and low noise, and therefore have come to be widely popular in offices and homes. Particularly, an ownership rate of inkjet recording apparatuses in homes increases in accordance with increase of an ownership rate of personal computers in homes.

Various recording schemes are available for image formation apparatuses, e.g., an inkjet recording scheme of forming an image by jetting ink from nozzles, and a laser beam recording scheme of forming an image by making toner adhere. An image formation apparatus (i.e., an inkjet recording apparatus) which forms an image according to the inkjet recording scheme has a small size and is available at a low price, and high-quality full-color images equivalent to photographs can be obtained. Therefore, the inkjet recording apparatus is overwhelmingly popular in homes, in comparison with image formation apparatuses which employ other recording schemes. On the other hand, the inkjet recording apparatuses can not satisfactorily improve a printing speed, and is therefore only limitedly popular in offices.

The following two problems are major factors which hinder improvement of a printing speed of the inkjet recording apparatus. One problem is that there is a difficulty in increasing a size of an inkjet recording head. There is another problem that the printing speed can not easily be improved since a penetration speed of ink penetrating into a sheet and image quality are generally contrary to each other. The latter problem is particularly conspicuous for ordinary sheets.

Ink ejected from the inkjet recording head penetrates into a sheet and develops a color by a pigment component contained in the ink. At this time, the ink needs to penetrate into the sheet within a predetermined time period. If the ink does not penetrate into the sheet within a predetermined time period, the ink remains on a surface of the sheet and therefore returns from the sheet, thereby degrading image quality. Further, the ink adheres to a conveying roller pair, thereby polluting other sheets. Therefore, in order to improve the printing speed with maintaining high resolution in the inkjet recording apparatus, applied ink needs to be dried rapidly, for example. However, a great calorie is required to force moisture contained in the ink to vaporize. Therefore, various methods have been disclosed to improve an apparent drying speed by processing a sheet or by arranging ingredients of ink to make the sheet rapidly absorb the ink. However, if ingredients of ink are arranged to increase an absorption speed of the ink into a sheet, the ink permeates deep into the sheet and soaks into the back of the sheet, i.e., a so-called strike through takes place, and the ink spreads. As a result, pixel dots become larger and image quality degrades. Further, pigment in the ink which is not fixed to a surface causes insufficient density, which degrades color development property.

JP-A 56-89595 (KOKAI) discloses a method of applying ink to a sheet after applying a reaction liquid to a recording surface of the sheet to make pigment in the ink coagulate near the surface. JP-A 3-183554 (KOKAI) discloses a method of vibrating a sheet by making an ultrasonic generation unit into surface-contact with a back surface of the sheet applied with ink, so that a surface tension of an ink droplet on the sheet is decreased to make the sheet absorb the ink.

In addition, when a sheet is applied with water-based ink, the sheet then wrinkles due to moisture in the ink. Particularly, an ordinary sheet has a non-uniform interior structure, and therefore easily wrinkles. Wrinkling takes place in a short time, and the sheet is deformed into an uneven shape. Therefore, if a distance between an inkjet recording head and a sheet being conveyed is small, a sheet may have contact with the inkjet recording head. Particularly, in an inkjet recording apparatus in which a plurality of inkjet recording heads are arranged parallel at intervals maintained in a conveying direction of a sheet, the sheet passes one after another of the inkjet recording heads provided in a downstream side along a conveying path. Therefore, print quality deteriorates when the sheet wrinkles, and the sheet may further have contact with any inkjet recording head and be thereby stained. In a conventional inkjet recording apparatus, ingredients of ink are arranged so as to suppress wrinkling.

In the inkjet recording apparatus disclosed in JP-A 56-89595 (KOKAI), a reaction liquid is applied to a whole surface of a sheet, and causes a problem that a texture of the sheet changes or that the sheet emits a smell peculiar to the reaction liquid. If the inkjet recording apparatus is configured to selectively apply the reaction liquid to a particular area of the sheet, there is a problem that heads for applying the reaction liquid need to be prepared separately and increase costs.

In the inkjet recording apparatus disclosed in JP-A 3-183554 (KOKAI), a sheet applied with ink is conveyed in surface-contact with a flat surface of the ultrasonic generation unit. This gives rise to a problem that degree of contact between the sheet and the ultrasonic generation unit is too little to transmit sufficient vibration to the sheet and absorption of ink becomes uneven. Further, since the sheet cannot be prevented from wrinkling due to water-based ink, the sheet makes contact with the inkjet recording head, and degrades print quality.

Accordingly, the inkjet recording apparatus is demanded to rapidly absorb ink applied to a sheet, in order to improve the recording speed and image quality at the same time.

### BRIEF DESCRIPTION OF THE DRAWINGS

FIG. 1 is a cross-sectional view schematically showing an inkjet recording apparatus according to an embodiment;

FIG. 2 is a block diagram schematically showing the inkjet recording apparatus shown in FIG. 1;

FIG. 3 is a perspective view of an example arrangement of a vibratory member and an ultrasonic vibrator which are shown in FIG. 1;

FIG. 4 is a cross-sectional view showing a vibratory member shown in FIG. 1;

FIG. 5 is a perspective view showing another example arrangement of the vibratory member and the ultrasonic vibrator shown in FIG. 1; and

FIG. 6 is a perspective view showing a comparative example of the vibratory member shown in FIG. 1.

### DETAILED DESCRIPTION

In general, according to one embodiment, an inkjet recording apparatus includes a conveying unit, a first inkjet recording head, and a first vibratory unit. The conveying unit is configured to convey a recording medium along a conveying path. The recording medium includes a first surface and a second surface which are opposed to each other. The first inkjet recording head is arranged on the conveying path and is configured to eject a first ink toward the first surface to apply the first ink to the recording medium. The first vibratory unit is configured to apply an ultrasonic vibration to the recording medium. The first vibratory unit is arranged on the conveying path downstream of the first inkjet recording head and includes a first end part configured to make substantially line contact with the second surface along a width direction of the recording medium. The width direction is substantially perpendicular to a conveying direction in which the recording medium is conveyed.

Hereinafter, inkjet recording apparatuses and methods according to various embodiments will be described with reference to the accompanying drawings.

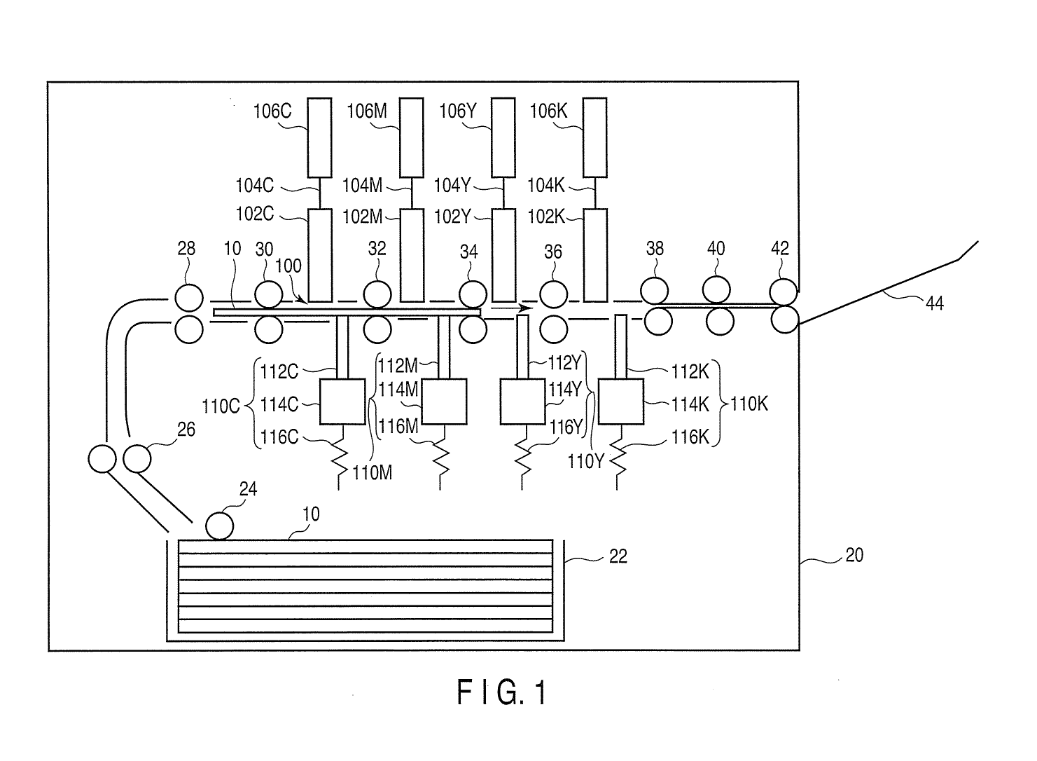

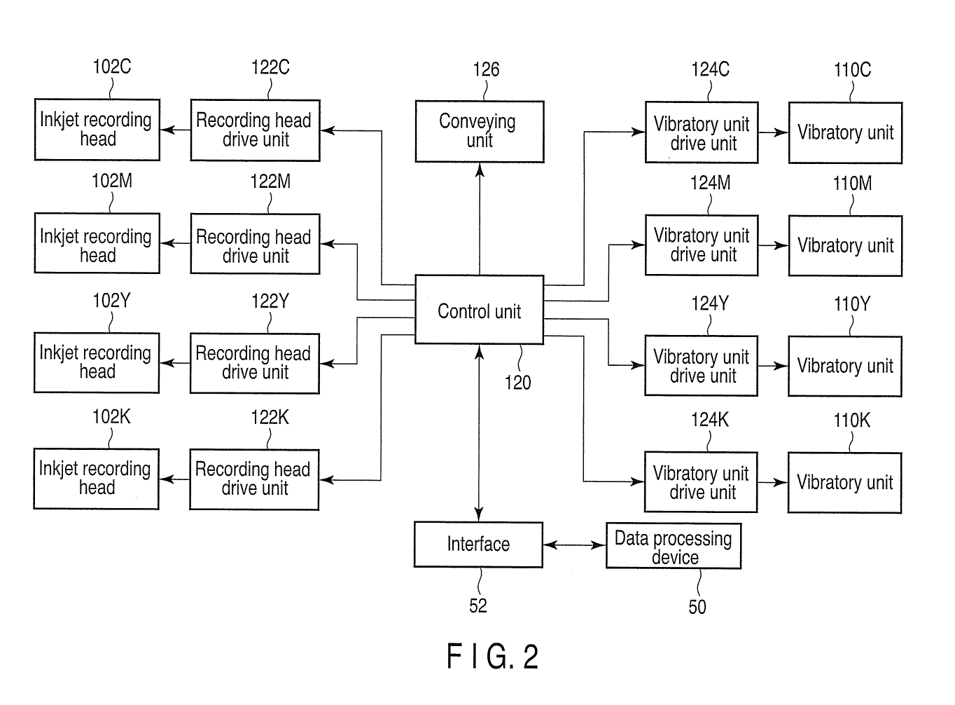

FIG. 1 is a cross-sectional view schematically showing the arrangement of an inkjet recording apparatus according to an embodiment. FIG. 2 is a block diagram showing the inkjet recording apparatus of FIG. 1. As shown in FIG. 1, the inkjet recording apparatus includes four inkjet recording heads 102C, 102M, 102Y, and 102K (hereinafter, simply referred to as recording heads) which eject water-based inks of respectively, different colors. The recording heads 102C, 102M, 102Y, and 102K are fixed inside a housing 20. Inks are ejected from the recording heads 102C, 102M, 102Y, and 102K toward a recording medium 10 which is conveyed in a conveying direction denoted by an arrow shown in FIG. 1, thereby forming an image on the recording medium 10. The term “recording medium” described herein means a paper-like medium on which an image is to be formed, such as a sheet of paper. In the embodiments, the recording medium is simply referred to as a “sheet” for simplicity of explanation and the sheet may include a paper-like medium. Also in the embodiments, a recording surface of the sheet where images are formed is simply referred to as a “surface”, and a surface opposed to the recording surface is referred to as a “back surface”.

The recording heads 102C, 102M, 102Y, and 102K are arranged at substantially equal intervals along a conveying direction of the sheet 10. In each of the recording heads 102C, 102M, 102Y, and 102K, a plurality of recording elements (not shown) such as piezoelectric elements are linearly arrayed in a width direction of the sheet 10, i.e., in a direction which is perpendicular to the conveying direction of the sheet 10 and parallel to a surface of the sheet 10. A plurality of nozzles (not shown) for ejecting inks are provided so as to correspond to the recording elements. In the recording heads 102C, 102M, 102Y, and 102K, the recording elements are driven by recording head drive units 122C, 122M, 122Y, and 122K shown in FIG. 2, and accordingly, inks are ejected from nozzles corresponding to the recording elements. In the embodiments, an in-plane direction of a sheet 10 which is perpendicular to the conveying direction of the sheet 10 is referred to as a width direction of the sheet 10 (or simply a width direction). A direction of the sheet surface (i.e., a direction in which the surface of the sheet 10 is directed) which is perpendicular to the conveying direction and width direction corresponds to a thickness direction of the sheet 10. The term “width” means a length in a width direction. For example, a sheet width denotes a length of a sheet in the width direction which is perpendicular to the conveying direction.

In the inkjet recording apparatus shown in FIG. 1, the recording heads 102C, 102M, 102Y, and 102K are fixed inside the housing 20, or namely, unmoved as opposed to the sheet 10 being conveyed. Therefore, the width of the recording heads 102C, 102M, 102Y, and 102K, i.e., the width over which the recording elements are arrayed is determined to be a width over which images can be formed on the sheet 10.

The recording heads 102C, 102M, 102Y, and 102K are respectively connected to ink cartridges 106C, 106M, 106Y, and 106K through tubes 104C, 104M, 104Y, and 104K. The ink cartridges 106C 106M, 106Y, and 106K are respectively filled with cyan, magenta, yellow, and black water-based inks. These inks are respectively supplied to the recording heads 102C, 102M, 102Y, and 102K through the tubes 104C, 104M, 104Y, and 104K from the ink cartridges 106C 106M, 106Y, and 106K. The recording heads 102C, 102M, 102Y, and 102K are respectively supplied with inks of single colors, and the cyan, magenta, yellow, and black inks are sequentially applied to the sheet 10 being conveyed, thereby to form a full-color image on the sheet 10.

An image formation unit 100 in which the recording heads 102C, 102M, 102Y, and 102K are provided is provided with vibratory units 110C, 110M, 110Y, and 110K which vibrate the sheet 10, respectively corresponding to the recording heads 102C, 102M, 102Y, and 102K. The vibratory units 110C, 110M, 110Y, and 110K are provided in a side opposite to a side in which the recording heads are provided, with a conveying path interposed in between, i.e., in a side opposite to a back surface of the sheet 10 being conveyed. Further, the vibratory units 110C, 110M, 110Y, and 110K are provided in a downstream side of respectively corresponding recording heads 102C, 102M, 102Y, and 102K along the conveying path. Specifically, the vibratory unit 110C is provided in an upstream side of the recording head 102M adjacent to the recording head 102C along the conveying path. The vibratory unit 110M is provided in an upstream side of the recording head 102Y adjacent to the recording head 102M along the conveying path. The vibratory unit 110Y is provided in an upstream side of the recording head 102K adjacent to the recording head 102Y along the conveying path. That is, the recording heads 102C, 102M, 102Y, and 102K and the vibratory units 110C, 110M, 110Y, and 110K are arranged on the conveying path in an order of the recording head 102C, vibratory unit 110C, recording head 102M, vibratory unit 110M, recording head 102Y, vibratory unit 110Y, recording head 102K, and vibratory unit 110K toward a downstream side from an upstream side.

In the inkjet recording apparatus shown in FIG. 1, an ink is jetted from a recording head (for example, the recording head 102C) toward the sheet 10 so that minute ink droplets are made adhere to the sheet 10. The minute ink droplets are absorbed into the sheet 10 due to capillary phenomenon. An amount and a speed thereof are determined by ink-absorbency of the sheet 10 to the ink and a surface tension of the ink droplet. There are ink droplets which are not absorbed in the sheet 10 after a constant time period. In this state, the sheet 10 is vibrated by a vibratory unit (for example, the vibratory unit 110C). As the sheet 10 is vibrated, the ink droplets are vibrated thereby decreasing the surface tension of the ink droplets, and the ink adhering to the surface of the sheet 10 is easily absorbed into the sheet 10.

The vibratory units 1100, 110M, 110Y, and 110K respectively includes: vibratory members 112C, 112M, 112Y, and 112K formed so as to make contact with the back surface of the sheet 10 conveyed over a whole width of the sheet; ultrasonic vibrators 114C, 114M, 114Y, and 114K which are joined to the vibratory members 112C, 112M, 112Y, and 112K and ultrasonically vibrate; and elastic members 116C, 116M, 116Y, and 116K which elastically or resiliently support the vibratory members 112C, 112M, 112Y, and 112K and ultrasonic vibrators 114C, 114M, 114Y, and 114K to be able to vibrate. The ultrasonic vibrators 114C, 114M, 114Y, and 114K include, for example, layered piezoelectric elements, and are driven and vibrated by the vibratory unit drive units 124C, 124M, 124Y, and 124K shown in FIG. 2 at a predetermined frequency within an ultrasonic range (for example, 20 kHz to 2.4 MHz). Frequencies beyond 2.4 MHz are used by ultrasonic atomization devices which apply vibration to a liquid to atomize the liquid, and disagree with the intent which makes inks be absorbed in the sheet 10. Therefore, a frequency of vibration to be applied to the sheet 10 is preferably 2.4 MHz or lower.

The vibratory members 112C, 112M, 112Y, and 112K joined to the ultrasonic vibrators 114C, 114M, 114Y, and 114K are vibrated substantially at the same frequency as the ultrasonic vibrators 114C, 114M, 114Y, and 114K. A frequency of ultrasonic vibration generated by the ultrasonic vibrators 114C, 114M, 114Y, and 114K is determined depending on a resonance frequency of the ultrasonic vibrators 114C, 114M, 114Y, and 114K and the vibratory members 112C, 112M, 112Y, and 112K.

The vibratory members 112C, 112M, 112Y, and 112K which are vibrated by the ultrasonic vibrators 114C, 114M, 114Y, and 114K are elastically supported inside the housing 20 by the elastic members 116C, 116M, 116Y, and 116K, such as coil springs, plate springs and the like, in a manner that the vibratory members 112C, 112M, 112Y, and 112K are pressed to the sheet 10 with a force containing components in the thickness direction of the sheet 10. The elastic members 116C, 116M, 116Y, and 116K each may be made of a material which generates a repulsive force in response to compressive displacement, such as a sponge, or may include a mechanism which uses an electro-magnetic force. In this manner, the sheet 10 applied with inks by the recording heads 102C, 102M, 102Y, and 102K is brought into contact with the vibratory members 112C, 112M, 112Y, and 112K, which are vibrating at a particular frequency, and is thereby vibrated while the sheet 10 is conveyed.

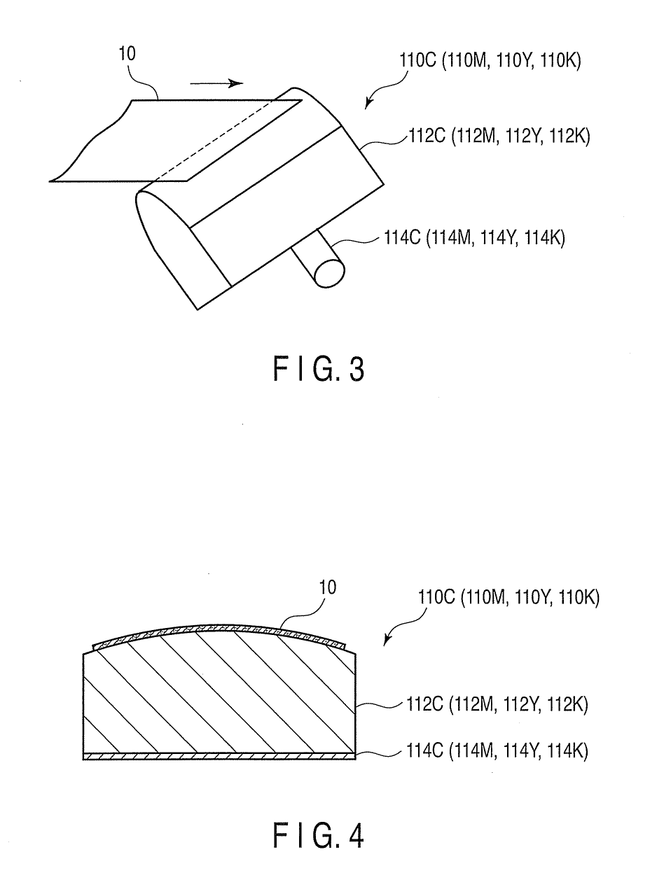

FIGS. 1 and 3 show the vibratory units, as an example, in which the vibratory members 112C, 112M, 112Y, and 112K, the ultrasonic vibrators 114C, 114M, 114Y, and 114K, and the elastic members 116C, 116M, 116Y, and 116K are respectively included as individual components. The vibratory units are not limited to this example. For example, the ultrasonic vibrators are mainly manufactured from metal as a material, and the ultrasonic vibrators may therefore be formed integrally with the vibratory members. Alternatively, the vibratory members may be formed integrally with the elastic members.

Image data indicating an image to be formed on the sheet 10 is subjected to image processing by software (or driver) installed in an external data processing device 50, e.g., in a personal computer. The processed image data is transmitted to a control unit 120 in the inkjet recording apparatus through an interface 52. When the control unit 120 receives the image data, the control unit 120 then controls the recording head drive units 122C, 122M, 122Y, and 122K and the vibratory unit drive units 124C, 124M, 124Y, and 124K in accordance with the received image data.

The recording head drive units 122C, 122M, 122Y, and 122K respectively drive the recording heads 102C, 102M, 102Y, and 102K. Specifically, the recording elements provided in the recording heads 102C, 102M, 102Y, and 102K are respectively driven by the recording head drive units 122C, 122M, 122Y, and 122K. Thereby, an image according to the image data is formed on the sheet 10.

At the same time when the recording heads 102C, 102M, 102Y, and 102K are driven, the ultrasonic vibrators 114C, 114M, 114Y, and 114K of the vibratory units 110C, 110M, 110Y, and 110K are applied with an alternating current voltage at a predetermined frequency from the vibratory unit drive units 124C, 124M, 124Y, and 124K, respectively. When the alternating current voltage at the predetermined frequency is applied, the ultrasonic vibrators 114C, 114M, 114Y, and 114K are then vibrated. Vibration is transmitted from the ultrasonic vibrators 114C, 114M, 114Y, and 114K through the vibratory members 112C, 112M, 112Y, and 112K to the sheet 10 applied with the inks by the recording heads 102C, 102M, 102Y, and 102K.

Further, the control unit 120 controls the sheet conveying unit (also called sheet conveying mechanism) 126 which conveys the sheet 10 so as to drive a sheet feed roller 24, registration roller pair 28, and paired conveyor belts 30, 32, 34, 36, 38, and 40. The sheet conveying unit 126 is controlled to be synchronized with operations of the recording heads 102C, 102M, 102Y, and 102K and the vibratory units 110C, 110M, 110Y, and 110K so that the sheet 10 is conveyed at optimum timing. For example, the control unit 120 includes, for example, an application specific integrated circuit (ASIC) for processing image data thereby to control the drive units 122C, 122M, 122Y, 122K, 124C, 124M, 124Y, 124K, and 126, and a memory (for example, a RAM) which temporarily stores image data.

The housing 20 shown in FIG. 1 is provided with a sheet feed cassette 22 to hold sheets 10. In the sheet feed cassette 22, one or more sheets 10 are stacked. FIG. 1 shows an example in which one sheet feed cassette 22 is provided for the purpose of simplifying FIG. 1. Alternatively, the inkjet recording apparatus may be provided with a plurality of sheet feed cassettes. Further, a manual cassette (not shown) is provided on an outer frame of the housing 20, and the sheets 10 may be fed from the manual cassette.

From the sheet feed cassette 22, the sheets 10 are picked up one after another by a pickup roller 24 and guided into a conveying path. The picked-up sheets 10 each are conveyed, by the intermediate conveying roller pair 26, to the registration roller pair 28 along the conveying path which is defined by conveyance guides. By the registration roller pair 28, the front edge of each sheet 10 is brought into contact with a nip part of the registration roller pair 28, and inclination of the sheet 10 is corrected, i.e., the sheet 10 is aligned. The registration roller pair 28 corrects a skew of the sheet 10, and conveys the sheet 10 to the image formation 100 unit at predetermined timing.

In an image formation unit 100, the recording heads 102C, 102M, 102Y, and 102K each are driven in accordance with image data, and inks of single colors are sequentially applied to the sheet 10, thereby forming a full-color image. Also in the image formation unit 100, the recording heads 102C, 102M, 102Y, and 102K each are driven in accordance with the image data, and the vibratory units 110C, 110M, 110Y, and 110K are driven. The sheet 10 subjected to image formation is vibrated by corresponding one of the vibratory units 110C, 110M, 110Y, and 110K each time when an ink is applied from any of the recording heads 102C, 102M, 102Y, and 102K. The sheet 10 subjected to the image formation is conveyed to a sheet discharge roller pair 42 by the paired conveyor belts 32, 34, 36, 38, and 40. The sheet 10 is then fed out of the housing 20 by the sheet feed roller pair 42, and is discharged onto a sheet discharge tray 44 provided on an outer frame of the housing 20.

The inkjet recording apparatus of FIG. 1 shows an example in which four recording heads 102C, 102M, 102Y, and 102K are provided in the housing 20. However, the inkjet recording apparatus is not limited to this example but only one recording head may be provided or two, three, five, or more recording heads may be provided in line.

The vibratory units which vibrate the sheet 10 applied with inks are not limited to a case in which the same number of vibratory units 110C, 110M, 110Y, and 110K as the recording heads 102C, 102M, 102Y, and 102K are provided but one or more vibratory units need to be provided. When one vibratory unit is provided for a plurality of recording heads, one vibratory unit is provided in a downstream side of every recording head along the conveying path in a manner that the sheet 10 on which a full-color image has been formed by the individuals of the recording heads is vibrated.

Next, the vibratory units 110C, 110M, 110Y, and 110K will be described in more detail with reference to FIGS. 3 to 5. The vibratory units 110C, 110M, 110Y, and 110K are formed to have the same structure as each other. In the following, only the vibratory unit 110C will be described to simplify description. That is, when sign C is included in reference signs assigned to individual elements, the sign C may be interpreted to be replaceable with any of M, Y, and K.

FIG. 3 shows an example arrangement of the vibratory member 112C and ultrasonic vibrator 114C included in the vibratory unit 110C. The vibratory member 112C is formed to have a larger width than a width over which the recording head 102C can form an image, and is positioned so as to make contact with a back surface of the sheet 10 conveyed along the conveying path in the conveying direction denoted by an arrow. Further, the vibratory member 112C is formed to have cross-sections all of which are formed to be tapered to narrow from a proximal end part joined to the ultrasonic vibrator 114C toward a top end part in contact with the sheet 10, where the cross-sections are taken along a plane perpendicular to the width direction of the sheet 10. That is, the vibratory member 112C is formed to make substantially line contact with the back surface of the sheet 10 in the width direction of the sheet 10. Further, a contact surface of the vibratory member 112C in contact with the sheet 10, i.e., a surface of the vibratory member 112C which is opposed to a back surface of the sheet 10 being conveyed is formed as a curved surface, and is brought into arcuately line contact with the sheet 10. When the vibratory member 112C is formed in a shape as described above, the sheet 10 is conveyed in contact with the vibratory member 112C through a minimum surface, i.e., kept in substantially line contact with the vibratory member 112C. When the sheet 10 is made in substantially line contact with the vibratory member 112C, the contact between the sheet 10 and the vibratory member 112C improves, and the vibratory member 112C is made in even contact with the sheet 10 being conveyed. Accordingly, the vibratory unit 110C can uniformly vibrate the sheet 10 applied with an ink by the recording head 102C, and ink droplets adhering to the surface of the sheet 10 can be rapidly absorbed into the sheet 10.

Here, substantial line contact of the vibratory member (for example, the vibratory member 112C) with the sheet 10 means contact of the vibratory member with the sheet 10 within a range of not greater than about 2.5% of the width of the sheet 10 in the conveying direction of the sheet 10. For example, when the sheet 10 having an A4 size is made in line contact with the vibratory member, the sheet 10 is made in contact with the vibratory member within a length of being not greater than about 5.25 mm in the conveying direction of the sheet 10.

The inkjet recording apparatus shown in FIG. 1 can form an image on the sheet 10, e.g., an ordinary sheet. A standardized sheet of B5, A4, or A3 can be used as the ordinary sheet. For example, the sheet size of A4 has a width of 210 mm and length of 297 mm. When the sheet 10 is made in substantially line contact with the vibratory member 112C, the elastic member 112C can be made in even contact with the sheet 10 having even a large sheet size such as A4.

Further, the vibratory member 112C is arranged so as to protrude in a thickness direction of the sheet 10 from the conveying path of the sheet 10. Since the sheet 10 applied with an ink is conveyed with the vibratory member 112C made in contact with a back surface of the sheet 10, the sheet 10 is deformed in a convex shape from a back surface side toward a surface side when the sheet 10 is conveyed. The elastic member 116C provides the vibratory member 112C with the restoring force in the thickness direction of the sheet 10 so that the vibratory member 112C is pressed to the sheet 10 conveyed. Therefore, the vibratory member 112C can be made in stable contact with the sheet 10 over the whole width of the sheet.

If an image is formed on the sheet 10 by a water-based ink, the sheet 10 absorbs moisture, and the sheet 10 therefore may wrinkle. That is, the sheet 10 may be deformed in a shape which is uneven in the thickness direction. The sheet 10 is conveyed with a constant gap maintained between the surface of the sheet 10 and the recording heads 102C, 102M, 102Y, and 102K, e.g., 0.5 to 2.0 mm. Thus, the sheet 10 is conveyed, maintained close to the recording heads 102C, 102M, 102Y, and 102K. Therefore, if the sheet 10 wrinkles, the sheet 10 may then make contact with the recording heads 102C, 102M, 102Y, and 102K.

In the inkjet recording apparatus shown in FIG. 1, the vibratory members 112C, 112M, 112Y, and 112K are pressed to the sheet 10 which is conveyed so as to maintain flatness by the paired conveyor belts so that wrinkles on the sheet 10 applied with inks is smoothed. Accordingly, the absorption speed of the water-based ink is improved and wrinkles occurring on the sheet 10 can be reduced.

Further, as shown in FIG. 4, the vibratory member 112C is formed to have a contact end part having a shape which is curved to be convex, viewed from a conveying direction. That is, an upper end part of the vibratory member 112C made in contact with the sheet 10 has a shape curved to be convex upward (in the thickness direction) of the sheet 10 in a plane vertical to the sheet 10 along the width direction. Accordingly, when the sheet 10 being conveyed is made in contact with the vibratory member 112C, the sheet 10 is deformed into a convex shape in the thickness direction of the sheet 10. If the sheet 10 is forced to be deformed in the thickness direction, the sheet 10 and the vibratory member 112C are made in stable contact with each other even when the sheet 10 is conveyed as the sheet 10 is bent.

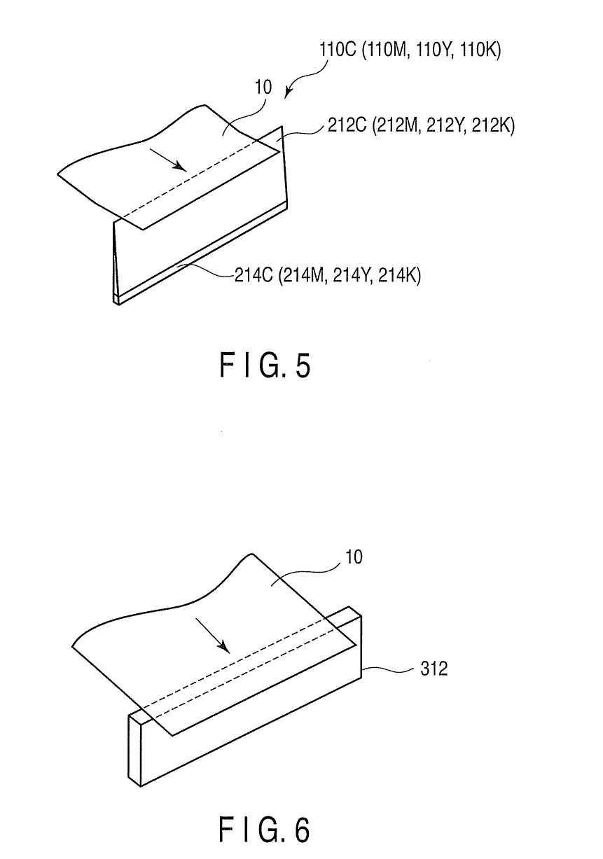

FIG. 5 shows another example arrangement of the vibratory member and ultrasonic vibrator which are included in the vibratory unit 110C. As shown in FIG. 5, the vibratory member 212C is formed in a manner that each of all cross-sections taken along a plane vertical to the width direction of the sheet 10 has a substantially isosceles triangular shape. In this case, the sheet 10 is conveyed in line contact with an edge (or an end part) of the vibratory member 212C. Thus, when the vibratory member 212C is positioned such that the sheet 10 makes contact with the edge formed on the vibratory member 212C, the vibratory member 212C and the sheet 10 are certainly made in line contact with each other. The same ultrasonic vibrator 114C as shown in FIG. 3 can be used as the ultrasonic vibrator 214C.

In the vibratory member 212C shown in FIG. 5, an end part (or contact end part) which makes contact with the sheet 10 is curved to be convex, as shown in FIG. 4. Therefore, the sheet 10 makes stable contact with the vibratory member 212C.

FIG. 6 shows a vibratory member 312 in which a vibratory member is formed in a substantially rectangular parallelepiped shape, as a comparative example of the vibratory member 112C according to the embodiment. As shown in FIG. 6, the vibratory member 312 is formed in a substantially rectangular parallelepiped shape, and the sheet 10 is conveyed in surface-contact with a surface of the vibratory member 312. In this case, a contact between the sheet 10 and the vibratory member 312 is reduced due to a thickness and bending of the sheet 10, and vibration is therefore not sufficiently transmitted to the sheet 10, causing a problem that inks are not sufficiently absorbed in the sheet 10.

The vibratory members 112C, 112M, 112Y, and 112K according to the present embodiment are formed to make substantially line contact with the sheet 10. Further, the vibratory member 112C, 112M, 112Y, and 112K are elastically supported to be applied with up-pushing forces by the elastic members 116C, 116M, 116Y, and 116K. Accordingly, press forces which contain thickness-directional components to push up the sheet 10 are applied from vibratory members 112C, 112M, 112Y, and 112K. The sheet 10 is made in stable contact with the vibratory members 112C, 112M, 112Y, and 112K.

As has been described above, the inkjet recording apparatus according to the present embodiment is provided with the recording heads 102C, 102M, 102Y, and 102K which eject water-based inks, and the vibratory units 110C, 110M, 110Y, and 110K which apply ultrasonic vibration to the sheet 10 applied with inks corresponding to the recording heads 102C, 102M, 102Y, and 102K. The sheet 10 applied with the inks is made in substantially line contact with the vibratory units 110C, 110M, 110Y, and 110K over the whole width of the sheet, and is applied with press forces containing components in the thickness direction by the vibratory units 110C, 110M, 110Y, and 110K. Accordingly, the sheet 10 applied with inks can be vibrated stably, and the inks can be rapidly absorbed into the sheet 10. Further, wrinkles occurring on the sheet 10 can be reduced since the sheet 10 is conveyed while the wrinkles on the sheet 10 is smoothed by the vibratory units 110C, 110M, 110Y, and 110K. When the inks are rapidly absorbed in the sheet 10, pigments contained in the inks are stably fixed to the surface of the sheet 10. Even when the sheet 10 is conveyed at a fast speed, the inks do not adhere to the paired conveyor belts 32, 34, 36, or 38. Accordingly, the printing speed can be improved, and the image quality and recording quality can be improved as well.

The vibratory units 110C, 110M, 110Y, and 110K each are formed in a manner that a contact part which makes contact with the sheet 10 has cross-sections each having a shape curved to be convex in the thickness direction of the sheet 10 wherein the cross-sections are taken along a plane vertical to the width direction of the sheet 10. In this case, the sheet 10 applied with inks is forcedly deformed to be convex in the thickness direction when the sheet 10 is made in substantially line contact over the whole width of the sheet. In this manner, the vibratory units 110C, 110M, 110Y, and 110K can be made in stable contact with vibratory units 110C, 110M, 110Y, and 110K, and can therefore certainly vibrate the sheet 10.

A thin sheet-like member capable of transmitting ultrasonic vibration may be provided between the back surface of the sheet 10 and the vibratory units 110C, 110M, 110Y, and 110K. For example, vibration can be transmitted through a PET sheet which is used as an OHP sheet. This is a method which is often used to prevent sheets from jamming when there is unevenness on a conveying path of sheets. The embodiment may employ this method in order to prevent jamming of the sheets 10 due to unevenness of the vibratory units. The PET sheet is a thin sheet which does not hinder vibration from being transmitted in the thickness direction. On the other side, vibration hardly spreads in plane directions, and does therefore not influence the configuration of the embodiment.

Examples of ingredients of each of the inks used in the inkjet recording apparatus according to the embodiment are cited below. Ingredients of each of the inks cited below are examples and are not limited to these examples.

### [Black 1]

Self-dispersion-type carbon black dispersion liquid

| | | |
|---|---|---|
| (Manufactured by Cabot | 8.0 | weight % |
| Specialty Chemicals Inc.) | | |
| (Concentration of Carbon- | | |
| black solid content) | | |
| Glycerin | 30.0 | weight % |
| Ethylene glycol | 0.5 | weight % |
| monobutyl ether | | |
| Surfynol 465 | 1.0 | weight % |
| Proxel XL-2(S) | 0.2 | weight % |
| Ion-exchange water | residual (60.3 | weight %) |

### [Black 2]

Self-dispersion-type carbon black dispersion liquid

| | | |
|---|---|---|
| (Manufactured by Cabot | 8.0 | weight % |
| Specialty Chemicals Inc.) | | |
| (Concentration of Carbon- | | |
| black solid content) | | |
| Glycerin | 30.0 | weight % |
| Ethylene glycol | 10.0 | weight % |
| Diethylene glycol | 5.0 | weight % |
| monobutyl ether | | |
| Surfynol 465 | 1.0 | weight % |
| Proxel XL-2(S) | 0.2 | weight % |
| Ion-exchange water | residual (45.8 | weight %) |

### [Yellow]

Self-dispersion-type yellow dispersion liquid

| | | |
|---|---|---|
| (Manufactured by Cabot | 6.0 | weight % |
| Specialty Chemicals Inc.) | | |
| (Concentration of Yellow- | | |
| pigment solid content) | | |
| Glycerin | 45.0 | weight % |
| Ethylene glycol | 5.0 | weight % |
| monobutyl ether | | |
| Surfynol 465 | 1.0 | weight % |
| Proxel XL-2(S) | 0.2 | weight % |
| Ion-exchange water | residual (42.8 | weight %) |

### [Magenta]

High-molecule dispersant self-dispersion-type magenta dispersion liquid

| | | |
|---|---|---|
| (Manufactured by Fuji Pigment Co., Ltd.) | 6.0 | weight % |
| (Concentration of Magenta-pigment | | |
| solid content) | | |
| Glycerin | 45.0 | weight % |
| Diethylene glycol monobutyl ether | 5.0 | weight % |
| Surfynol 465 | 1.0 | weight % |
| Proxel XL-2(S) | 0.2 | weight % |
| Ion-exchange water | residual (42.8 | weight %) |

### [Cyan]

High-molecule dispersant self-dispersion-type magenta dispersion liquid

| | | |
|---|---|---|
| (Manufactured by Fuji Pigment Co., Ltd.) | 6.0 | weight % |
| (Concentration of Cyan-pigment | | |
| solid content) | | |
| Glycerin | 45.0 | weight % |
| Triethylene glycol monobutyl ether | 5.0 | weight % |
| Surfynol 465 | 1.0 | weight % |
| Proxel XL-2(S) | 0.2 | weight % |
| Ion-exchange water | residual (57.2 | weight %) |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet recording apparatus comprising:
a conveying unit configured to convey a recording medium along a conveying path, the recording medium comprising a first surface and a second surface which are opposed to each other;
a first inkjet recording head arranged on the conveying path and configured to eject a first ink toward the first surface to apply the first ink to the recording medium; and
a first vibratory unit configured to apply an ultrasonic vibration to the recording medium, the first vibratory unit being arranged on the conveying path downstream of the first inkjet recording head, the first vibratory unit comprising a first end part configured to make substantially line contact with the second surface along a width direction of the recording medium, the width direction being substantially perpendicular to a conveying direction in which the recording medium is conveyed.

2. The apparatus according to claim 1, further comprising a second inkjet recording head arranged on the conveying path downstream of the first vibratory unit and configured to eject a second ink toward the first surface to apply the second ink to the recording medium, the second ink being different from the first ink.

3. The apparatus according to claim 2, further comprising a second vibratory unit configured to apply an ultrasonic vibration to the recording medium, the second vibratory unit being arranged on the conveying path downstream of the second inkjet recording head, the second vibratory unit comprising a second end part configured to make substantially line contact with the second surface along the width direction.

4. The apparatus according to claim 3, further comprising a housing, wherein
the first vibratory unit comprises:
a first ultrasonic vibrator configured to vibrate at a frequency within an ultrasonic range;
a first vibratory member joined to the first ultrasonic vibrator and configured to be vibrated by the first ultrasonic vibrator; and
a first elastic member configured to elastically support the first vibratory member in the housing, and
the second vibratory unit comprises:
a second ultrasonic vibrator configured to vibrate at a frequency within the ultrasonic range;
a second vibratory member joined to the second ultrasonic vibrator and configured to be vibrated by the second ultrasonic vibrator; and
a second elastic member configured to elastically support the second vibratory member in the housing.

5. The apparatus according to claim 4, wherein the first vibratory member comprises the first end part, the second vibratory member comprises the second end part, and the first end part and the second end part are curved to be convex in a direction in which the first surface is directed, and are made in line contact with the recording medium along the width direction.

6. The apparatus according to claim 2, further comprising a housing; wherein each of the first inkjet recording head and the second inkjet recording head comprises a plurality of recording elements linearly arrayed along the width direction, and is fixed inside the housing.

7. The apparatus according to claim 1, further comprising a housing, wherein
the first vibratory unit comprises:
an ultrasonic vibrator configured to vibrate at a frequency within an ultrasonic range;
a vibratory member joined to the ultrasonic vibrator and configured to be vibrated by the ultrasonic vibrator; and
an elastic member configured to elastically support the vibratory member in the housing.

8. An inkjet recording method comprising:
conveying a recording medium along a conveying path, the recording medium comprising a first surface and a second surface which are opposed to each other;
preparing a first inkjet recording head arranged on the conveying path and configured to eject a first ink toward the first surface to apply the first ink to the recording medium; and
preparing a first vibratory unit configured to apply an ultrasonic vibration to the recording medium, the first vibratory unit being arranged on the conveying path downstream of the first inkjet recording head and comprising a first end part configured to make substantially line contact with the second surface along a width direction of the recording medium, the width direction being substantially perpendicular to a conveying direction in which the recording medium is conveyed.
